(19) United States
(12) Patent Application Publication
(10) Pub. No.: US 2019/0114651 A1
(43) Pub. Date: Apr. 18, 2019

(54) METHOD FOR DETERMIING SOCIAL MEDIA INFLUENCER UNIQUE FOLLOWER CONTRIBUTION TO A GROUP OF INFLUENCERS

(71) Applicant: MOGIMO, INC., New York, NY (US)

(72) Inventors: Gil EYAL, Hoboken, NJ (US); Guy TAMIR, Kfar Saba (IL); Liad SHEKEL, Ramat-Hasharon (IL); Roey SHAMIR, Tel Aviv (IL)

(73) Assignee: MOGIMO, INC., New York, NY (US)

(21) Appl. No.: 15/785,554

(22) Filed: Oct. 17, 2017

(51) Int. Cl. G06Q 30/02; G06Q 50/00; G06F 17/30

(52) U.S. Cl. CPC G06Q 30/0201; G06F 17/30867; G06Q 50/01; G06Q 30/0204

(57) ABSTRACT

A method for identification of unique followers for social network influencers includes: storing social network profiles, each related to a user profile in a social network including a profile identifier and a plurality of follower identifiers; receiving a unique follower analysis request including request data; identifying a plurality of matching social network profiles of the social network profiles based on the request data and, in each of the matching social network profiles, a statistically significant number of follower identifiers of the included plurality of follower identifiers; identifying, for each pair of matching social network profiles, a number of unique followers for each matching social network profile based on the follower identifiers included in the statistically significant number of follower identifiers identified for the respective profile; and transmitting the number of unique followers and profile identifier for each matching social network profile.

### FIELD

The present disclosure relates to the identification of unique followers for social network influencers, specifically the comparison of a statistically significant number of followers for pairs or subsets of potential influencers in a social network to identify unique followers thereof, for maximizing follower contribution among a group of potential influencers.

### BACKGROUND

Social networks have provided countless individuals with the ability to reconnect with lost friends and acquaintances, stay in touch with distant friends and family, and be exposed to content they may have missed otherwise. While social networks provide a vast number of benefits to their users, they are also often of benefit to brands, agencies, advertisers, businesses and other entities interested in reaching out to new customers due to the vast user base and reach of social networks.

As a result, social networks often provide the opportunity for entities to engage their influential or highly followed users to promote a post on the social network, also sometimes referred to as a sponsored post or other indication of the post being made as part of a service. Traditionally, promoted posts are offered by an influential social media user via a social network for a cost, with the benefit being that the post is displayed to a vast number of the users of the social network, guaranteeing a wide reach for the entity.

However, while such techniques may be useful in reaching potential customers, identifying users of a social network that may be effective for such a post may be difficult. Often times, little information outside of the number of followers for any given potential influencer may be unavailable. Some methods have been developed that are designed to analyze the exposure of a post promoted by an influencer on a social network to assist in the determination of the effectiveness of such a campaign, such as described in U.S. patent application Ser. No. 15/392,392, entitled “A Method for Analyzing Influencer Marketing Effectiveness,” filed on Dec. 28, 2016, which is herein incorporated by reference in its entirety. While such methods may assist in determining the effectiveness of marketing through an influencer, it may not be able to instruct a marketer or advertiser as to what influencer or influencers to use for their marketing.

Thus, there is a need for a technological solution to determine how many unique followers a potential influencer on a social network may have, specifically with respect to other specific influencers on the social network.

### SUMMARY

The present disclosure provides a description of systems and methods for the identification of unique followers for a social network influencer. A group of influencers on one or more social networks are considered, where the followers for each individual influencer are compared, separately, to each of the other influencers in the group. As a result, the uniqueness of one's followers are compared to each of the others, individually, which can be used to determine an optimal set of influencers in the group that can achieve the highest number of unique followers while minimizing the number of influencers required in the group. As a result, redundant influencers can be avoided, which may lower costs as well as oversaturation of promoted posts, while at the same time maintaining a high level of exposure. Thus, the methods and systems discussed herein can provide for greater exposure at less cost through an automated system that may be impossible to perform manually due to the significant number of followers in any given social network, particularly when influence is considered across a plurality of social networks for any given individual.

A method for identification of unique followers for social network influencers includes: storing, in a social network database of a processing server, a plurality of social network profiles, wherein each social network profile is a structured data set configured to store data related to a user profile in a social network including at least a profile identifier and a plurality of follower identifiers; receiving, by a receiving device of the processing server, a unique follower analysis request from a computing system, wherein the unique follower analysis request includes at least request data; executing, by a querying module of the processing server, a query on the social network database to identify a plurality of matching social network profiles of the plurality of social network profiles based on the request data, and to identify, in each of the matching social network profiles, a statistically significant number of follower identifiers of the included plurality of follower identifiers; identifying, by a data identification module of the processing server, for each pair of matching social network profiles, a number of unique followers for each matching social network profile based on the follower identifiers included in the statistically significant number of follower identifiers identified for the respective matching social network profile; and electronically transmitting, by a transmitting device of the processing server, at least the number of unique followers and profile identifier for each matching social network profile to the computing system in response to the received unique follower analysis request.

A system for identification of influencer social network marketing effectiveness includes: a social network database of a processing server configured to store a plurality of social network profiles, wherein each social network profile is a structured data set configured to store data related to a user profile in a social network including at least a profile identifier and a plurality of follower identifiers; a receiving device of the processing server configured to receive a unique follower analysis request from a computing system, wherein the unique follower analysis request includes at least request data; a querying module of the processing server configured to execute a query on the social network database to identify a plurality of matching social network profiles of the plurality of social network profiles based on the request data, and to identify, in each of the matching social network profiles, a statistically significant number of follower identifiers of the included plurality of follower identifiers; a data identification module of the processing server configured to identify, for each pair of matching social network profiles, a number of unique followers for each matching social network profile based on the follower identifiers included in the statistically significant number of follower identifiers identified for the respective matching social network profile; and a transmitting device of the processing server configured to electronically transmit at least the number of unique followers and profile identifier for each matching social network profile to the computing system in response to the received unique follower analysis request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identification of unique followers for social network influencers in accordance with exemplary embodiments.

FIG. 2 is a block diagram illustrating the processing server of the system of FIG. 1 for identifying unique followers for social network influencers in accordance with exemplary embodiments.

FIG. 3 is a flow diagram illustrating a process for the identification and reporting of unique followers in a social network using the processing server of FIG. 2 in accordance with exemplary embodiments.

FIG. 4 is a flow chart illustrating an exemplary method for identification of unique followers in a social network in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

System for Identifying Unique Followers for Social Network Influencers

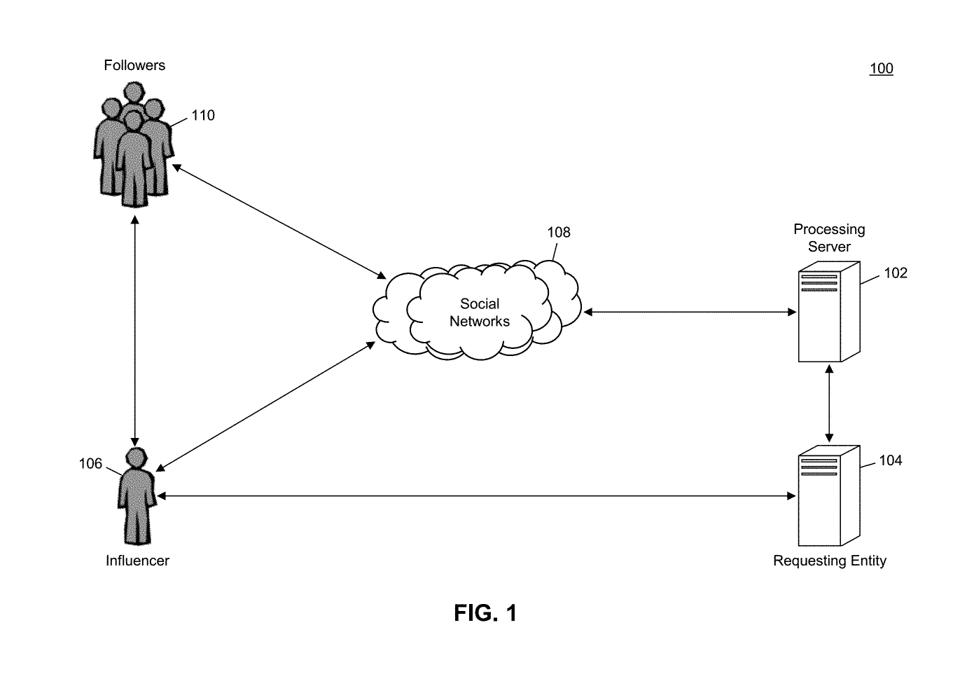

FIG. 1 illustrates a system 100 for the identification of an optimal number of unique followers for a set of social network influencers in a group of potential influencers across one or more social networks.

The system 100 may include a processing server 102. The processing server 102, discussed in more detail below, may be configured to identify a number of unique followers for any given potential influencer across one or more social networks as compared to other potential influencers to determine an optimal set of influencers to maximize effectiveness. In the system 100, the processing server 102 may receive a request from a requesting entity 104. The requesting entity 104 may be an advertiser, merchant, retailer, manufacturer, or other type of entity that may be interested in identifying a set of influencers 106 across one or more social networks 108. For example, the requesting entity 104 may be a product manufacturer that wants to identify a set of influencers 106 that may be useful for advertising their product through promoted posts on one or more social networks 108.

The requesting entity 104 may submit the request to the processing server 102, which may be referred to herein as a unique follower analysis request. The request may include data that may be used by the processing server 102 to identify a group of potential influencers 106. In some embodiments, the data may include a profile identifier associated with each of the potential influencers 106 for one or more social networks 108, such as a social network handle, identification number, or other similar data that may be used to identify the account associated with a particular influencer 106 on the social network 108. In some cases, the profile identifier may be associated with a profile for an influencer 106 registered with the processing server 102 that may correspond to a plurality of different profiles across multiple social networks 108. For instance, a single influencer 106 may have a profile across each of a number of different social networks 108, where the processing server 102 may use a single profile identifier to refer to the influencer 106 and, by extension, each of their profiles on the individual social networks 108. In some embodiments, the data included in the request may include demographic characteristics, where the processing server 102 may be configured to identify influencers 106 whose followers match the requested demographic characteristics. For example, the requesting entity 104 may want to identify influencers 106 whose majority of followers match a target market for the requesting entity 104, where the processing server 102 may thus identify such influencers 106. Such demographic characteristics may include, for instance, age, gender, income, geographic location, residential status, marital status, familial status, ethnicity, nationality, occupation, education, etc. Methods for identifying demographic characteristics of social network followers and the identification of influencers 106 thereof are discussed in more detail in U.S. patent application Ser. No. 15/550,627, entitled “Method and System for Analysis of User Data Based on Social Network Connections,” filed on Aug. 11, 2017, which is herein incorporated by reference in its entirety.

The processing server 102 may be configured to identify each influencer 106 based on the data included in the request and may then identify the social network users that follow the influencer 106 on one or more of the social networks 108, referred to herein as “followers.” In an exemplary embodiment, the processing server 102 may have identification data associated with each individual follower 110. For example, the processing server 102 may have a list of the handle, username, identification number, or other such identification data for each follower 110 for a given influencer 106 across each social network 108 on which the influencer 106 may be identified. Such a list may be provided by the social network 108, influencer 106, or identified by the processing server 102 via analysis of the profile of the influencer 106 on a given social network 108, such as using a specialized crawler designed to analyze the profile of the influencer 106 to parse each of the followers 110 therefrom. The processing server 102 may thus obtain a list of each individual follower 110 of an influencer 106 across each of their social networks 108.

The processing server 102 may then identify the number of unique followers 110 for each of the influencers 106 in the group of influencers as requested by the requesting entity 104. In cases where the requesting entity 104 specifies target demographic characteristics, the processing server 102 may, in some such cases, identify only those followers 110 unique to the influencer 106 that match the requested demographic characteristics. To identify the unique followers for each influencer 106, the processing server 102 may compare each of the influencers 106 with every other influencer 106 in the group, separately, where the processing server 102 may identify every potential pair of influencers 106 in the group and identify, for each pair, the unique followers for each influencer 106 in the pair as compared to the other. For example, the processing server 102 may identify the followers 110 for each influencer 106 in a pair to identify the profile identifiers of followers 110 for each influencer 106 that cannot be found in the list of profile identifiers for the other influencer 106, where the resulting followers 110 are determined to be unique followers 110 for that influencer 106 with respect to the other influencer in the pair.

In some embodiments, the processing server 102 may consider the entire list of followers 110 for each influencer 106 in the group. In other embodiments, the processing server 102 may utilize a sample of a statistically significant number of followers 110, where the resulting proportion of unique followers may be attributable to the entire group of followers 110 for an influencer 106. In such embodiments, the use of the statistically significant number of followers may enable the processing server 102 to identify the unique followers for an influencer 106 fast and more efficiently due to a decrease in the amount of data being processed, while the use of a statistically significant number may ensure accuracy. The processing server 102 may use any suitable method for identifying the number of followers 110 that may be considered statistically significant for an influencer 106. In these embodiments, the number of followers 110 determined to be statistically significant may be based on either the lower or higher number of followers 110 for each influencer 106 in a pair, or across every influencer 106 in the group, as may be dependent on the type of method used to identify the number. In embodiments where a statistically significant number of followers 110 may be sampled and used, the processing server 102 may attribute a percentage of unique followers 110 for the influencer 106 for the sample in a given pair to the total number of followers 110 for the influencer 106 in that pair. For example, the processing server 102 may analyze two influencers, influencer A and influencer B, where influencer A has 10,000,000 followers 110 and influencer B has 6,000,000 followers 110. The processing server 102 may use a sample of 100,000 followers 110 for each, and determine, from the sample, that influencer A has 43,000 unique followers 110 in the sample and influencer B has 5,000 unique followers 110 in the sample. These proportions may be attributed to the full list of followers 110 for each influencer 106 to determine that influencer A has 4,300,000 unique followers 110 total, and influencer B has 300,000 unique followers 110 total.

In some embodiments, the number of unique followers 110 that may be attributed to an influencer 106 may be additionally based on a vertical, such as an industry, to which the influencer 106 or the request is related. For instance, in one embodiment, the processing server 102 may utilize a sample of a statistically significant number of followers 110 for several influencers 106 in each of the social networks 108 to which the influencer 106 belongs. In another embodiment, the processing server 102 may utilize a sample of a statistically significant number of followers 110 for several influencers 106 in a single social network 108, where the result may be attributed to other social networks 108 based on the associated vertical. For example, in the fashion industry, a vast majority (e.g., 90%) of followers 110 of an influencer 106 may follow that influencer 106 on every social network 108 used by the influencer 106, whereas, in another industry, such as hiking, a significantly less portion of followers 110 (e.g., 30%) may follow the influencer 106 on multiple social networks 108. In such cases, the processing server 102 may take a vertical into account when selecting a sample or samples and/or attributing the results of analysis of a sample to the followers 110 of an influencer across one or more social networks 108.

The processing server 102 may thus determine the number of unique followers 110 that each influencer 106 has with respect to every other individual influencer 106 in the group of requested influencers 106. In some embodiments, the processing server 102 may provide such information to the requesting entity 104, where the requesting entity 104 may use the information accordingly. For instance, in the above example, the requesting entity 104 may decide to not utilize influencer B in a marketing campaign due to the low number of unique followers 110, or may provide influencer A with a more favorable marketing deal to the larger number of unique followers 110.

In other embodiments, the processing server 102 may be configured to perform additional analysis of the unique followers 110 for each influencer 106 for providing to the requesting entity 104. For instance, in one embodiment, the processing server 102 may determine an optimal set of influencers 106 in the group of influencers 106. In such embodiments, the optimal set may include a list of influencers 106 that includes the highest ratio of unique followers to number of influencers 106. For example, the processing server 102 may identify ten influencers 106 in the group, and a maximum total of 5,000,000 unique followers 110. The influencers 106 may be divided that a set of six specific influencers 106 has 3,000,000 unique followers 110, while any seven influencers 106 only has 3,200,000 unique followers 110, any eight influencers only 3,400,000 unique followers 110, and any nine influencers 3,550,000 unique followers 110, while the best group of five influencers may have 2,200,000 unique followers 110. In such an example, the set of six specific influencers 106 provides for the most followers 110 on a per-influencer 106 basis, which may thus be optimal for the requesting entity 104.

In some cases, the processing server 102 may provide such data on all possible combinations of influencers 106 in the group. In some instances, the processing server 102 may provide an interface for such data, such as through a web page or application program, where the requesting entity 104 may be able to select or de-select each influencer 106 in the group to identify the corresponding effect on the total number of unique influencers, which may enable the requesting entity 104 to determine their own optimal set of influencers 106. In cases where demographic characteristics are requested by the requesting entity 104 or made available by the processing server 102, such an interface may illustrate the unique followers 110 for each influencer 106 or set of influencers that are included in a set of demographic characteristics (e.g., as requested) or may otherwise indicate demographic characteristics for the unique followers 110.

In some embodiments, the processing server 102 may provide a ranking of influencers 106 in the group based on the number of unique followers 110. For instance, in one example, the processing server 102 may determine the unique followers 110 for each pair of influencers 106, and may rank the influencers based on the overall total number of unique followers 110. In another example, the processing server 102 may place the influencer 106 with the overall highest number of unique followers 110 as first, but may then rank the next influencer 106 with respect to the number of unique followers 110 as compared to the influencer 106 in first. That influencer 106 may be second, where the influencer 106 that is to be placed third may be the influencer 106 with the highest number of unique followers 110 as compared to the first and second placed influencers 106. In such embodiments, such a listing of influencers 106, and the corresponding number of unique followers, may be provided to the requesting entity 104 and/or used in determining the optimal set of influencers 106.

The methods and systems discussed herein may thus enable the processing server 102 to identify the number of unique followers 110 for each influencer 106 in a group of influencers across one or more social networks 108. In some cases, the data may be further used to identify an optimal set of influencers 106 in a proposed group of influencers 106, to maximize exposure to users of the social network(s) while minimizing the number of influencers 106 used. Thus, the processing server 102 can easily and efficiently increase efficiency for advertisers and marketers, particularly in instances where the number of followers 110 may be in the millions or tens or hundreds of millions.

### Processing Server

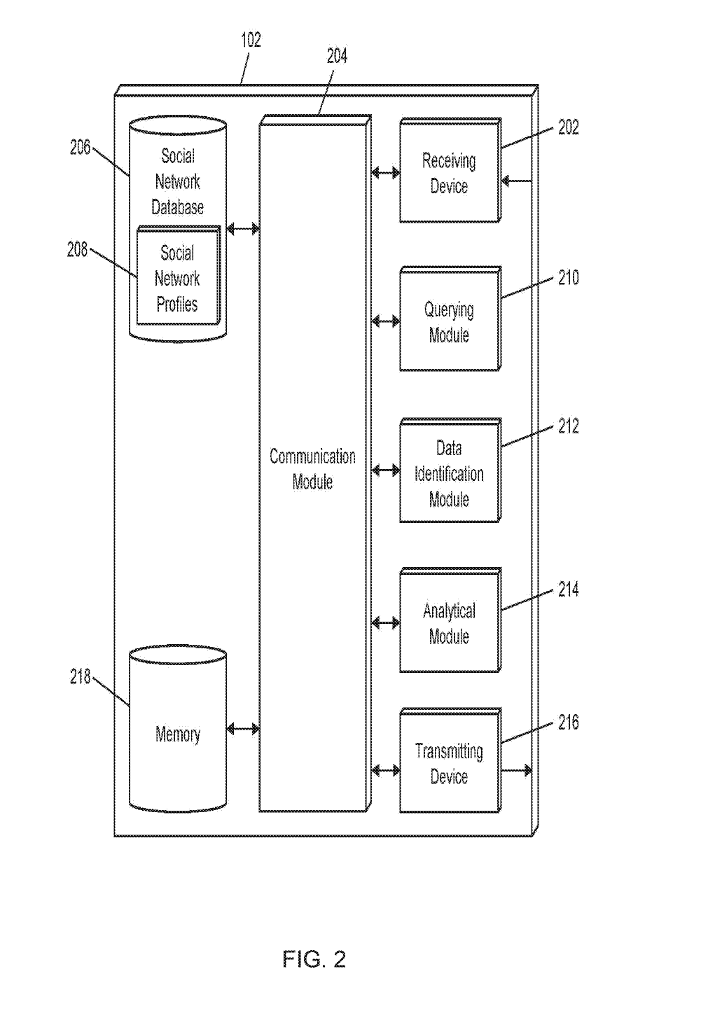

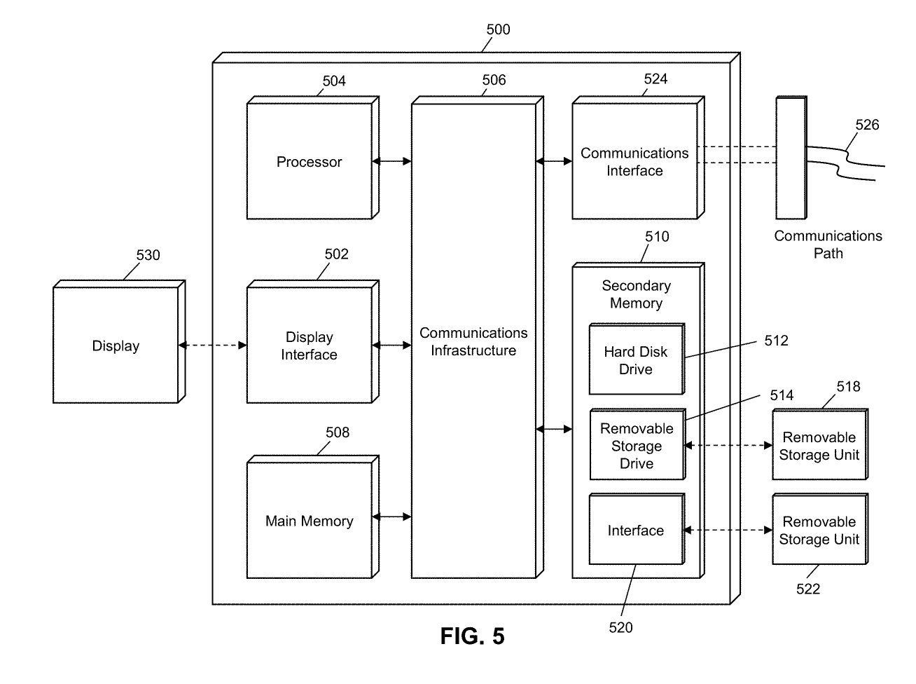

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from requesting entities 104 and social networks 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by requesting entities 104, which may be superimposed or otherwise encoded with a unique follower analysis request. Such a request may include profile identifiers associated with each of a group of influencers 106 across one or more social networks 108, and/or may include demographic characteristics for a target market that is sought by the requesting entity 104. In some cases, a request may also indicate the type of reporting or data being requested, such as if the requesting entity 104 wants raw data regarding unique followers 110 for each influencer 106, the optimal set of influencers 106, demographic characteristics of unique followers 110 in each pair of influencers 106, etc. The receiving device 202 may also be configured to receive data signals electronically transmitted by social networks 108. Such data signals may be superimposed or otherwise encoded with follower data regarding the followers 110 for a given influencer 106, which may include the profile identifier or other identification data associated with the influencer 106. In some cases, the data may be received in response to a request submitted to the social network 108 by the processing server 102 requesting the follower data for one or more specific influencers 106.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, data identification module 212, analytical module 214, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include a social network database 206. The social network database 206 may be configured to store a plurality of social network profiles 208 using a suitable data storage format and schema. The account database 206 may, in some embodiments, be a relational database that utilizes structured query language for the storage, identification, modifying, updating, accessing, etc. of structured data sets stored therein. Each social network profile 208 may be a structured data set configured to store data related to a profile across one or more social networks 108 and include, for instance, a profile identifier that is unique to the social network profile 208 and a list of follower identifiers associated with followers 110 of the related social network profile(s). In some embodiments, each social network profile 208 may be related to a single social network 108, where the profile identifier may be the unique identification data associated with the related social network profile on the single social network 108. In other embodiments, a single social network profile 208 may be related to profiles for a single person across a plurality of social networks 108, where the profile identifier may be a value that is unique to the social network profile 208 and where the social network profile 208 may further include identification data for the corresponding social network profile in each social network 108 as well as a list of follower identifiers for followers 110 of the related influencer 106 on each social network 108. In embodiments where multiple social networks 108 may be considered for an influencer 106, unique followers may be determined with respect to multiple social networks 108. For instance, the processing server 102 may identify that a single person follows the influencer 106 on three different social networks, and may thus count that person as a single unique follower 110. Methods for matching a social network profile for each of a plurality of social networks 108 to a single user are incorporated herein.

The processing server 102 may include a querying module 210. The querying module 210 may be configured to execute queries on databases to identify information. The querying module 210 may receive one or more data values or query strings, and may execute a query string based thereon on an indicated database, such as the social network database 206, to identify information stored therein. The querying module 210 may then output the identified information to an appropriate engine or module of the processing server 102 as necessary. The querying module 210 may, for example, execute a query on the social network database 206 to identify a social network profile 208 for each influencer 106 in a unique follower analysis request received by the receiving device 202 for identification of the list of follower identifiers included therein, to be used in determining the number of unique followers for each influencer 106.

The processing server 102 may also include a data identification module 212. The data identification module 212 may be configured to identify data for the processing server 102 for use in performing the functions discussed herein. The data identification module 212 may receive instructions as input, may identify data as instructed, and may output the identified data to another module or engine of the processing server 102. For example, the data identification module 212 may be configured to identify the number of unique followers 110 for each influencer 106 (e.g., via the associated social network profile 108) in a pair of influencers 106, and may repeat the identification for every possible pair in a group of influencers 106. In some cases, the data identification module 212 may be configured to identify demographic characteristics of followers 110 for a social network profile 208, and/or identify demographic characteristics among unique followers 110 or to identify only unique followers 110 that match a set of demographic characteristics.

The processing server 102 may further include an analytical module 214. The analytical module 214 may be configured to analyze data as part of the processes of the processing server 102 discussed herein. The analytical module 214 may receive instructions as input, may perform analysis as instructed, and may output a result of the analysis to another module or engine of the processing server 102. In some cases, the instructions may include data to be analyzed by the analytical module 214. In other cases, the analytical module 214 may be configured to identify the data to be used in the requested analysis. The analytical module 214 may be configured to, for example, analyze the unique followers 110 for each influencer 106 in a group of influencers to determine an optimal set of influencers 106, which may be a set of influencers 106 that has the highest ratio of unique followers 110 to number of influencers 106. In some cases, the analytical module 214 may be configured to rank influencers 106 based on unique followers 110, as discussed above.

The processing server 102 may also include a transmitting device 216. The transmitting device 216 may be configured to transmit data over one or more networks via one or more network protocols. In some instances, the transmitting device 216 may be configured to transmit data to requesting entities 104, social networks 108, and other entities via one or more communication methods, local area networks, wireless area networks, cellular communication, Bluetooth, radio frequency, the Internet, etc. In some embodiments, the transmitting device 216 may be comprised of multiple devices, such as different transmitting devices for transmitting data over different networks, such as a first transmitting device for transmitting data over a local area network and a second transmitting device for transmitting data via the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to requesting entities 104 that are superimposed or otherwise encoded with unique follower data identified by the processing server 102 as discussed herein, such as numbers of unique followers 110 for each influencer 106 in a group as requested, a ranking of influencers 106, an optimal set of influencers 106, reporting of the number of unique followers 110 for each pair of influencers 106, demographic characteristics of unique followers 110, etc. The transmitting device 216 may be configured to electronically transmit data signals to social networks 108, which may be superimposed or otherwise encoded with requests for follower data for a specific social network profile, such as may be associated with an influencer 106, where the request may include at least a profile identifier associated with the influencer 106 on the social network.

The processing server 102 may also include a memory 218. The memory 218 may be configured to store data for use by the processing server 102 in performing the functions discussed herein, such as public and private keys, symmetric keys, etc. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein. The memory 218 may be configured to store, for example, communication data for social networks 108, algorithms for ranking influencers 106, demographic characteristic data, etc.

### Process for Identifying Unique Followers for Social Network Influencers

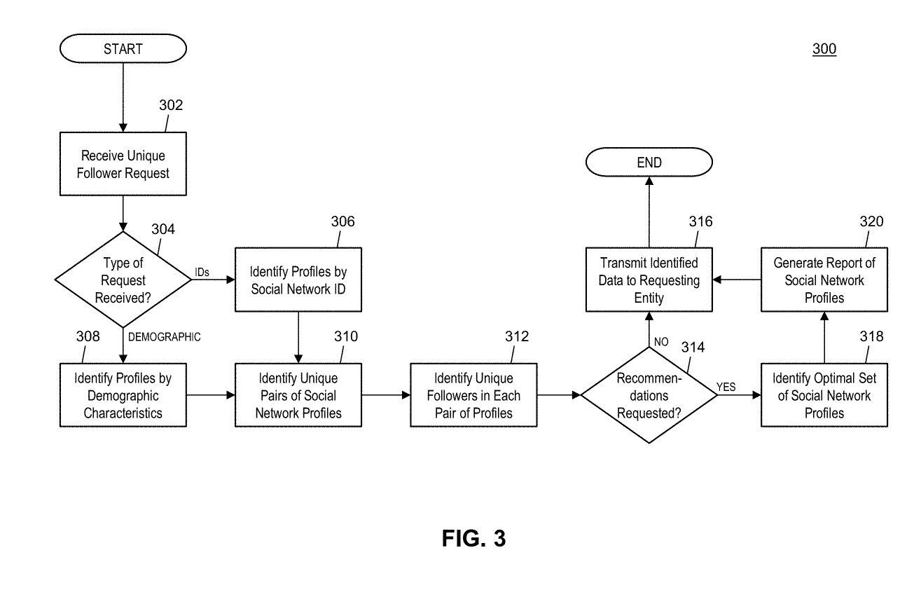

FIG. 3 illustrates an example process 300 executed by the processing server 102 in the system 100 for identifying unique followers for a group of influencers 106 in one or more social networks 108.

In step 302, the receiving device 202 of the processing server 102 may receive a unique follower request, which may request unique followers for a plurality of influencers 106 across one or more social networks 108. In some cases, the unique follower request may include a plurality of profile identifiers, where each profile identifier corresponds to a social network profile 208 associated with an influencer 106 in the group of influencers 106. In other cases, the unique follower request may include a plurality of demographic characteristics, and may further include if the unique followers 110 are to be identified based on the demographic characteristics (e.g., each unique follower 110 is to be associated with the characteristics) or if influencers 106 are to be identified based on demographic characteristics (e.g., of their followers 110).

In step 304, the processing server 102 may determine the type of request that is received based on the data included therein. If the request includes profile identifiers for a plurality of influencers 106, then, in step 306, the querying module 210 of the processing server 102 may execute a query on the social network database 206 to identify a social network profile 208 for each influencer 106 that includes the profile identifier included in the unique influencer request. If the request includes a plurality of demographic characteristics, then, in step 308, the querying module 210 of the processing server 102 may execute a query on the social network database 206 to identify a plurality of social network profiles 208 that include the plurality of demographic characteristics. Once the social network profiles 208 are identified, then, in step 310, the data identification module 212 may identify each possible combination of unique pairs and/or possible combination of unique subsets of social network profiles 208.

In step 312, the data identification module 212 may determine, for each of the unique pairs (e.g., or subsets, as applicable) of social network profiles 106, the number of unique followers in each based on the follower identifiers included in both of the social network profiles 106 being compared. In step 314, the processing server 102 may determine if recommendations for influencers 106 are requested by the requesting entity 104, such as may be based on the data included in the unique influencer request. If no recommendations are requested, then, in step 316, the transmitting device 216 of the processing server 102 may electronically transmit the number of unique followers for each social network profile 208, as associated with each corresponding profile identifier, to the requesting entity 104. If recommendations are requested, then, in step 318, the analytical module 214 of the processing server 102 may identify an optimal set of social network profiles 208, where the optimal set includes the highest number of unique followers 110 per influencer 106 based on the number of unique followers 110 determined for each of the social network profiles 208. In step 320, the data identification module 212 of the processing server 102 may generate a report of the social network profiles 208 that are determined to be in the set of optimal influencers and the data associated therewith. The process 300 may then proceed to step 316, where the report may be electronically transmitted to the requesting entity 104.

### Exemplary Method for Identification of Unique Followers for Social Network Influencers

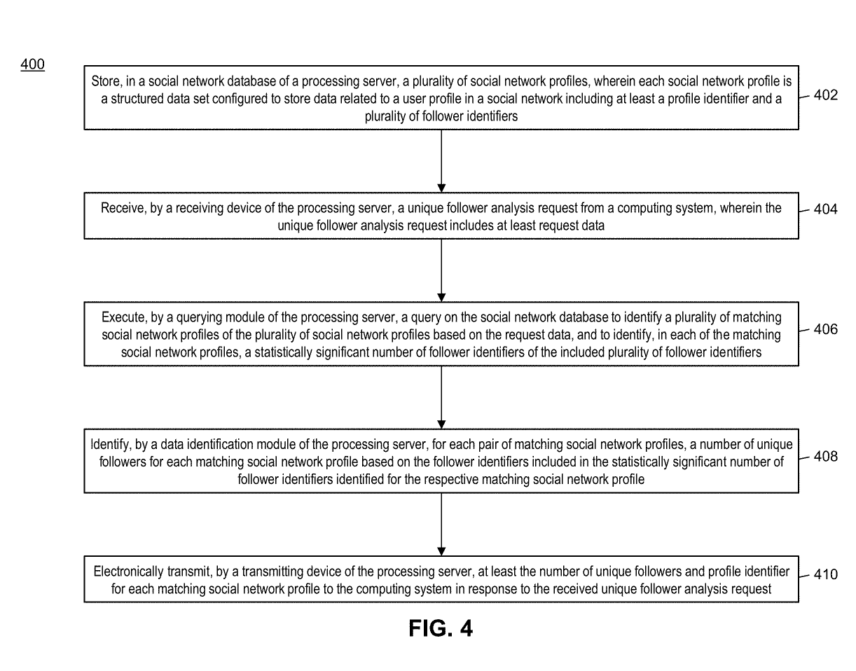

FIG. 4 illustrates a method 400 for the identification of a number unique followers for each of a plurality of influencers in one or more social networks.

In step 402, a plurality of social network profiles (e.g., social network profiles 208) may be stored in a social network database (e.g., the social network database 206) of a processing server (e.g., the processing server 102), wherein each social network profile is a structured data set configured to store data related to a user profile in a social network (e.g., a social network 108) including at least a profile identifier and a plurality of follower identifiers. In step 404, a unique follower analysis request may be received by a receiving device (e.g., the receiving device 202) of the processing server from a computing system (e.g., the requesting entity 104), wherein the unique follower analysis request includes at least requested data. In step 406, a query may be executed on the social network database by a querying module (e.g., the querying module 210) of the processing server to identify a plurality of matching social network profiles of the plurality of social network profiles based on the request data, and to identify, in each of the matching social network profiles, a statistically significant number of follower identifiers of the included plurality of follower identifiers.

In step 408, a number of unique followers for each matching social network profile may be identified by a data identification module (e.g., the data identification module 212) for each pair of matching social network profiles based on the follower identifiers included in the statistically significant number of follower identifiers identified for the respective matching social network profile. In step 410, at least the number of unique followers and profile identifier identified for each matching social network profile may be electronically transmitted by a transmitting device (e.g., the transmitting device 216) to the computing system in response to the received unique follower analysis request.

In one embodiment, the statistically significant number of follower identifiers may be based on one of: a smallest number of follower identifiers of the plurality of follower identifiers included in each of the matching social network profiles and a largest smallest number of follower identifiers of the plurality of follower identifiers included in each of the matching social network profiles. In some embodiments, the request data may include a plurality of profile identifiers, and the profile identifier included in each of the matching social network profiles may correspond to one of the plurality of profile identifiers. In one embodiment, each social network profile may further include a plurality of demographic characteristics, the request data may include a specified set of demographic characteristics, and the plurality of demographic characteristics included in each of the matching social network profiles may correspond to the specified set of demographic characteristics.

In some embodiments, the method 400 may further include determining, by an analytical module (e.g., the analytical module 214) of the processing server, an optimal set of the matching social network profiles based on a ratio of a number of matching social network profiles to a total number of unique followers based on the identified number of unique followers for each pair of matching social network profiles. In a further embodiment, the electronic transmission to the computing device may further include the determined optimal set of matching social network profiles. In one embodiment, the number of unique followers electronically transmitted for each matching social network profile may be a number of unique followers identified for the matching social network profile for every pair of matching social network profiles that includes the respective matching social network profile. In some embodiments, the number of unique followers electronically transmitted for each matching social network profile may include the number of unique followers for the matching social network profile in each pair of matching social network profiles that includes the respective matching social network profile.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for identification of unique followers for social network influencers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identification of unique followers for social network influencers, comprising:
storing, in a social network database of a processing server, a plurality of social network profiles, wherein each social network profile is a structured data set configured to store data related to a user profile in a social network including at least a profile identifier and a plurality of follower identifiers;
receiving, by a receiving device of the processing server, a unique follower analysis request from a computing system, wherein the unique follower analysis request includes at least request data;
executing, by a querying module of the processing server, a query on the social network database to identify a plurality of matching social network profiles of the plurality of social network profiles based on the request data, and to identify, in each of the matching social network profiles, a statistically significant number of follower identifiers of the included plurality of follower identifiers;
identifying, by a data identification module of the processing server, for each pair of matching social network profiles, a number of unique followers for each matching social network profile based on the follower identifiers included in the statistically significant number of follower identifiers identified for the respective matching social network profile; and
electronically transmitting, by a transmitting device of the processing server, at least the number of unique followers and profile identifier for each matching social network profile to the computing system in response to the received unique follower analysis request.

2. The method of claim 1, wherein the statistically significant number of follower identifiers is based on one of: a smallest number of follower identifiers of the plurality of follower identifiers included in each of the matching social network profiles and a largest smallest number of follower identifiers of the plurality of follower identifiers included in each of the matching social network profiles.

3. The method of claim 1, wherein
the request data includes a plurality of profile identifiers, and
the profile identifier included in each of the matching social network profiles corresponds to one of the plurality of profile identifiers.

4. The method of claim 1, wherein
each social network profile further includes a plurality of demographic characteristics,
the request data includes a specified set of demographic characteristics, and
the plurality of demographic characteristics included in each of the matching social network profiles corresponds to the specified set of demographic characteristics.

5. The method of claim 1, further comprising:
determining, by an analytical module of the processing server, an optimal set of the matching social network profiles based on a ratio of a number of matching social network profiles to a total number of unique followers based on the identified number of unique followers for each pair of matching social network profiles.

6. The method of claim 5, wherein the electronic transmission to the computing device further includes the determined optimal set of matching social network profiles.

7. The method of claim 1, wherein the number of unique followers electronically transmitted for each matching social network profile is a number of unique followers identified for the matching social network profile for every pair of matching social network profiles that includes the respective matching social network profile.

8. The method of claim 1, wherein the number of unique followers electronically transmitted for each matching social network profile includes the number of unique followers for the matching social network profile in each pair of matching social network profiles that includes the respective matching social network profile.

9. A system for identification of unique followers for social network influencers, comprising:
a social network database of a processing server configured to store a plurality of social network profiles, wherein each social network profile is a structured data set configured to store data related to a user profile in a social network including at least a profile identifier and a plurality of follower identifiers;
a receiving device of the processing server configured to receive a unique follower analysis request from a computing system, wherein the unique follower analysis request includes at least request data;
a querying module of the processing server configured to execute a query on the social network database to identify a plurality of matching social network profiles of the plurality of social network profiles based on the request data, and to identify, in each of the matching social network profiles, a statistically significant number of follower identifiers of the included plurality of follower identifiers;
a data identification module of the processing server configured to identify, for each pair of matching social network profiles, a number of unique followers for each matching social network profile based on the follower identifiers included in the statistically significant number of follower identifiers identified for the respective matching social network profile; and
a transmitting device of the processing server configured to electronically transmit at least the number of unique followers and profile identifier for each matching social network profile to the computing system in response to the received unique follower analysis request.

10. The system of claim 9, wherein the statistically significant number of follower identifiers is based on one of: a smallest number of follower identifiers of the plurality of follower identifiers included in each of the matching social network profiles and a largest smallest number of follower identifiers of the plurality of follower identifiers included in each of the matching social network profiles.

11. The system of claim 9, wherein
the request data includes a plurality of profile identifiers, and
the profile identifier included in each of the matching social network profiles corresponds to one of the plurality of profile identifiers.

12. The system of claim 9, wherein
each social network profile further includes a plurality of demographic characteristics,
the request data includes a specified set of demographic characteristics, and
the plurality of demographic characteristics included in each of the matching social network profiles corresponds to the specified set of demographic characteristics.

13. The system of claim 9, further comprising:
an analytical module of the processing server configured to determine an optimal set of the matching social network profiles based on a ratio of a number of matching social network profiles to a total number of unique followers based on the identified number of unique followers for each pair of matching social network profiles.

14. The system of claim 13, wherein the electronic transmission to the computing device further includes the determined optimal set of matching social network profiles.

15. The system of claim 9, wherein the number of unique followers electronically transmitted for each matching social network profile is a number of unique followers identified for the matching social network profile for every pair of matching social network profiles that includes the respective matching social network profile.

16. The system of claim 9, wherein the number of unique followers electronically transmitted for each matching social network profile includes the number of unique followers for the matching social network profile in each pair of matching social network profiles that includes the respective matching social network profile.
